(19) United States
(12) Patent Application Publication
(10) Pub. No.: US 2006/0098984 A1
(43) Pub. Date: May 11, 2006

(54) Optical signal communication apparatus and optical signal communication system employing the optical signal communication apparatus

(75) Inventors: Kazuhiro Sakai, Ashigarakami-gun (JP); Masaru Kijima, Ashigarakami-gun (JP); Tsutomu Hamada, Ashigarakami-gun (JP); Hisayoshi Mori, Ashigarakami-gun (JP); Osamu Ueno, Ashigarakami-gun (JP); Yoshihide Sato, Ashigarakami-gun (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/125,121

(22) Filed: May 10, 2005

(30) Foreign Application Priority Data
Nov. 10, 2004 (JP) 2004-326349

(51) Int. Cl. H04B 10/00

(52) U.S. Cl. 398/138

(57) ABSTRACT

An optical signal communication apparatus includes a light transceiving section, a digital signal control section and a flexible wiring board. The light transceiving section performs at least one of transmission and reception of optical signals. The digital signal control section is disposed in a casing body and processes digital electronic signals from the light transceiving section. The flexible wiring board connects the light transceiving section with the digital signal control section. An insulating member is provided at the casing body, and the flexible wiring board is disposed on the insulating member.

### CROSS-REFERENCE TO RELATED APPLICATION

This application claims priority under 35 USC 119 from Japanese Patent Application No. 2004-326349, the disclosure of which is incorporated by reference herein.

### BACKGROUND OF THE INVENTION

1. Field of the Invention

The present invention relates to an optical signal communication apparatus and to an optical signal communication system employing the optical signal communication apparatus.

2. Description of the Related Art

As liquid crystal panels, plasma displays and the like become higher in resolution, there are demands for transmission of large-volume image signals from hosts as unaltered digital signals. For example, with a differential signal standard known as TMDS (Transition Minimized Differential Signaling), a DVI (Digital Visual Interface) established by the industry group DDWG (Digital Display Working Group) transmits image data bit-by-bit with a high-speed signal of 1.65 Gbps, and transmits display information and suchlike from a display to a host in the form of a DDC signal, which is a low-speed signal.

Metal cables with shielding, which are widely used as display cables, are commonly employed as mediums for such communications. However, there has been a problem in that, because of the faster speeds of the signals, it is not possible to extend these cables over lengths of more than 10 m.

Accordingly, a system for converting these digital signals to light for propagation over long distances has been proposed (see Japanese Patent Application Laid-Open (JP-A) No. 2004-241915).

A light transmitting/receiving module of JP-A No. 2004-241915 has a structure in which a light transceiving section, which converts optical signals to electronic signals and/or converts electronic signals to optical signals, is connected with an electronic circuit board by a flexible wiring board. The light transceiving section and the electronic circuit board are arranged in a casing body, and the flexible wiring board touches a bottom face of the casing body. If there is a gap between a portion of the flexible wiring board and the bottom face, undesired radiation is generated, passes through the casing body from the flexible wiring board and leaks to the outside, which is a problem.

### SUMMARY OF THE INVENTION

The present invention has been made in view of the above circumstances and provides an optical signal communication apparatus which prevents undesired radiation being generated between a flexible wiring board and a casing body, in which casing body a light transceiving section and an electronic circuit board are disposed, and an optical signal communication system employing this optical signal communication apparatus.

A first aspect of the present invention is an optical signal communication apparatus including: a light transceiving section, which performs at least one of transmission and reception of optical signals; a digital signal control section which is disposed in a casing body and processes digital electronic signals from the light transceiving section; and a flexible wiring board connecting the light transceiving section with the digital signal control section, wherein the flexible wiring board is disposed on an insulating member provided at the casing body.

According to the first aspect of the present invention, a return current which flows in the flexible wiring board will not flow into the casing body. Therefore, undesired radiation will not be generated.

In a second aspect of the present invention, the insulating body includes a foam material.

According to the second aspect of the present invention, a foam material with a small dielectric constant is employed as the insulating body. Thus, it is possible to realize a completely insulated state between the flexible wiring board and the bottom face of the casing body. Therefore, return current flowing in the flexible wiring board will not flow into the casing body, and thus the generation of undesired radiation can be prevented.

In a third aspect of the present invention, the insulating body includes an electric wave-absorbing material.

According to the third aspect of the present invention, an radio wave-absorbing material is employed as the insulating body. Therefore, electromagnetic waves which are emitted from the flexible wiring board will be absorbed by the electric wave-absorbing material. As a result, transmission of electromagnetic waves to the casing body can be completely prevented, and thus the occurrence of undesired radiation between the flexible wiring board and the casing body can be reliably prevented.

A fourth aspect of the present invention is an optical signal communication apparatus including: a light transceiving section, which performs at least one of transmission and reception of optical signals; a digital signal control section which is disposed in a casing body and processes digital electronic signals from the light transceiving section; and a flexible wiring board connecting the light transceiving section with the digital signal control section, wherein the flexible wiring board is disposed along a recess portion formed at a bottom face of the casing body and the flexible wiring board is inflected such that an end portion thereof is substantially perpendicular to the bottom face of the casing body.

According to the fourth aspect of the present invention, the flexible wiring board and the casing body are closely contacted. Therefore, even if return current flowing in the flexible wiring board flows into the casing body, return current that flows in the casing body will not vary from location to location, and undesired radiation will not be generated.

A fifth aspect of the present invention is an optical signal communication apparatus including: a light transceiving section, which performs at least one of transmission and reception of optical signals; a digital signal control section which is disposed in a casing body and processes digital electronic signals from the light transceiving section; and a flexible wiring board connecting the light transceiving section with the digital signal control section, wherein a conductive member is disposed at a side of the flexible wiring board that faces a bottom face of the casing body.

According to the fifth aspect of the present invention, the conductive member is provided at the casing body bottom face side of the flexible wiring board. Hence, if the conductive member is in even partial contact with the bottom face of the casing body, the whole of the flexible wiring board will be in a state of contact with the bottom face of the casing body. As a result, return currents that flow in the flexible wiring board and the casing body will not vary from location to location, and undesired radiation will not be generated.

In a sixth aspect of the present invention, the conductive member includes a sheet form, a peripheral edge of which is covered with an insulating member.

According to the sixth aspect of the present invention, the peripheral edge of the sheet-form conductive member is covered with the insulating member. Hence, even if a portion of the sheet-form conductive member whose peripheral edge is covered with the insulating member peels away from the flexible wiring board, it will be the peripheral edge insulating member that touches another component, and there will be no direct contact by the conductive member. Therefore, there is no risk of a short-circuit.

A seventh aspect of the present invention is an optical signal communication apparatus including: a light transceiving section, which performs at least one of transmission and reception of optical signals; a digital signal control section which is disposed in a casing body and processes digital electronic signals from the light transceiving section; and a flexible wiring board connecting the light transceiving section with the digital signal control section, wherein the flexible wiring board is structured by at least two layers, including a signal wiring layer at which signal wiring is formed and a ground layer at which a grounded region is formed, the ground layer being disposed at a side of the flexible wiring board that faces a bottom face of the casing body.

According to the seventh aspect of the present invention, all return current flowing in the flexible wiring board flows through the ground layer, return current that flows in the casing body does not vary by location, and the generation of undesired radiation can be suppressed.

An eighth aspect of the present invention is an optical signal communication apparatus including: a light transceiving section, which performs at least one of transmission and reception of optical signals; a digital signal control section which is disposed in a casing body and processes digital electronic signals from the light transceiving section; and a flexible wiring board connecting the light transceiving section with the digital signal control section, wherein a pressing member is formed at the casing body, an intermediate portion of the flexible wiring board is inflected through approximately 180° for forming a loop portion, an end portion of the flexible wiring board is inflected to be substantially perpendicular to a bottom face of the casing body, and the pressing member presses the loop portion toward the casing body.

According to the eighth aspect of the present invention, the flexible wiring board is perpendicularly inflected with respect to the bottom face of the casing body, and is further inflected to 180° to form the loop portion. In such a case, a loop radius can be made smaller by this loop portion being pressed against the casing body by the pressing member. Thus, it is possible to cause the loop portion to touch the casing body over a wide region. Therefore, it is possible to realize a state in which the flexible wiring board is closely contacted with the casing body, and return current that flows in the casing body will not vary by location. Consequently, it is possible to reduce undesired radiation. A ninth aspect of the present invention is an optical signal communication system including: a first optical signal communication apparatus, which includes a first light transceiving section, which performs at least one of transmission and reception of optical signals, a first digital signal control section, which is disposed in a first casing body and performs at least one of processing digital electronic signals from the first light transceiving section and outputting digital electronic signals to a host via an electrical cable and processing digital electronic signals inputted from the host and outputting digital electronic signals to the first light transceiving section, and a first flexible wiring board connecting the first light transceiving section with the first digital signal control section; and a second optical signal communication apparatus, which includes a second light transceiving section, which performs at least one of transmission and reception of optical signals, a second digital signal control section, which is disposed in a second casing body and performs at least one of processing digital electronic signals from the second light transceiving section and outputting digital electronic signals to a monitor via an electrical cable and processing digital electronic signals inputted from the monitor and outputting digital electronic signals to the second light transceiving section, and a second flexible wiring board connecting the second light transceiving section with the second digital signal control section, wherein the first flexible wiring board is disposed on an insulating member provided at the first casing body and the second flexible wiring board is disposed on an insulating member provided at the second casing body.

According to the ninth aspect of the present invention, return currents flowing in the first flexible wiring board and the second flexible wiring board will not flow into the first casing body and the second casing body, respectively. Thus, an optical signal communication system in which undesired radiation will not be generated is provided.

With the structures described above, the present invention prevents undesired radiation being generated between a flexible wiring board and a casing body in which a light transceiving section and an electronic circuit board are disposed.

### BRIEF DESCRIPTION OF THE DRAWINGS

Preferred embodiments of the present invention will be described in detail based on the following figures, wherein:

FIG. 1 is a block diagram showing general structure of an optical signal communication system which is equipped with an optical signal communication apparatus of a first embodiment of the present invention;

FIG. 2 is a perspective view showing the optical signal communication apparatus of the embodiment of the present invention;

FIG. 3 is an exploded perspective view showing a receptacle of the optical signal communication apparatus of the embodiment of the present invention, and an optical signal transmission section and optical signal reception section which are fixed to the receptacle;

FIG. 4A is a plan sectional view of the optical signal communication apparatus of the embodiment of the present invention;

FIG. 4B is a side sectional view of the optical signal communication apparatus of the embodiment of the present invention;

FIG. 5 is a folded-out view of a flex-rigid board of an optical signal communication apparatus of a first embodiment of the present invention;

FIG. 6 is a perspective view showing a flex portion of the optical signal communication apparatus of the first embodiment of the present invention;

FIG. 7A is a view showing a flex portion of the optical signal communication apparatus of the first embodiment of the present invention, and is a side view showing a state in which the flex portion directly touches the casing body;

FIG. 7B is a view showing a flex portion of the optical signal communication apparatus of the first embodiment of the present invention, and is a side view showing a state in which an insulating member is adhered to the flex portion;

FIG. 8 is a side view showing a flex portion of an optical signal communication apparatus of a second embodiment of the present invention;

FIG. 9 is a side view showing a flex portion of an optical signal communication apparatus of a third embodiment of the present invention;

FIG. 10 is a perspective view showing a flex portion of an optical signal communication apparatus of another embodiment of the present invention;

FIG. 11A is a side view showing a flex portion of an optical signal communication apparatus of a fourth embodiment of the present invention;

FIG. 11B is an enlargement view showing a layer structure of the flex portion;

FIG. 12 is a perspective view showing a flex portion of an optical signal communication apparatus of a fifth embodiment of the present invention;

FIG. 13A is a view showing a flex portion of an optical signal communication apparatus of a sixth embodiment of the present invention, and is a side view showing a state in which the flex portion is not being pressed; and

FIG. 13B is a view showing the flex portion of the optical signal communication apparatus of the sixth embodiment of the present invention, and is a side view showing a state in which the flex portion is being pressed.

### DETAILED DESCRIPTION OF THE INVENTION

Herebelow, an optical signal communication apparatus 12 relating to an embodiment of the present invention will be described with reference to the drawings.

Overall Structure

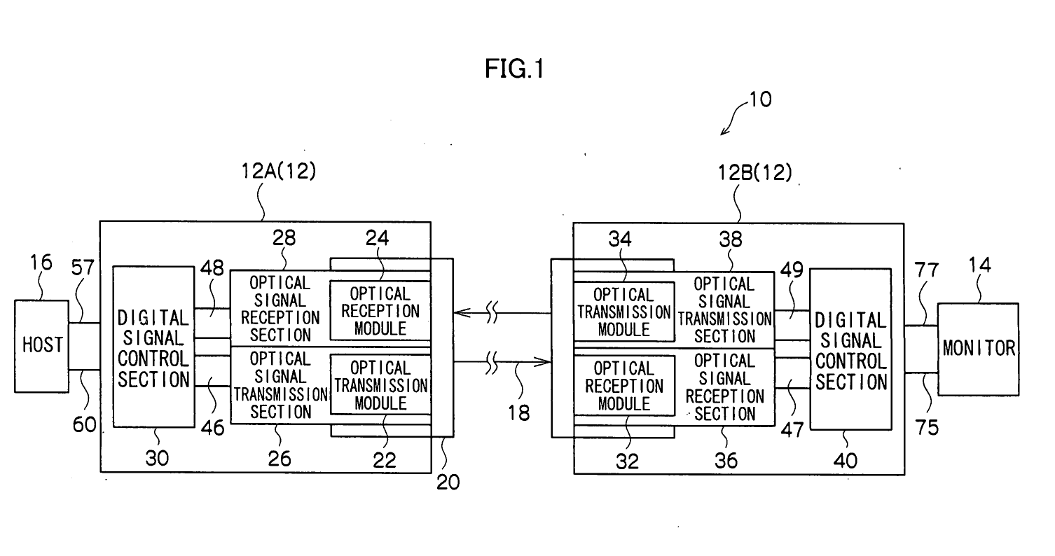

First, an image signal communication apparatus system 10, which is equipped with the optical signal communication apparatus 12 of the present embodiment, will be briefly described in accordance with FIG. 1.

The image signal communication apparatus system 10 displays image signals from a host 16 at a monitor 14. Image signals outputted from the host 16 are converted to optical signals by an optical signal communication apparatus 12A which is connected to the host 16, and are transmitted through optical fiber to an optical signal communication apparatus 12B which is connected to the monitor 14. The optical signal communication apparatus 12B converts the optical signals transmitted from the optical signal communication apparatus 12A to digital electronic signals, and an image is displayed at the monitor 14.

For the digital signals that are communicated by the optical signal communication apparatuses 12 (12A and 12B), the DVI established by the DDWG industry group, which is one among image signal standards, or the like is employed. In addition, non-DVI signals are employed separately from the DVI signals, for implementing exchanges of sound information and remote control information and the like.

Optical Signal Communication Device

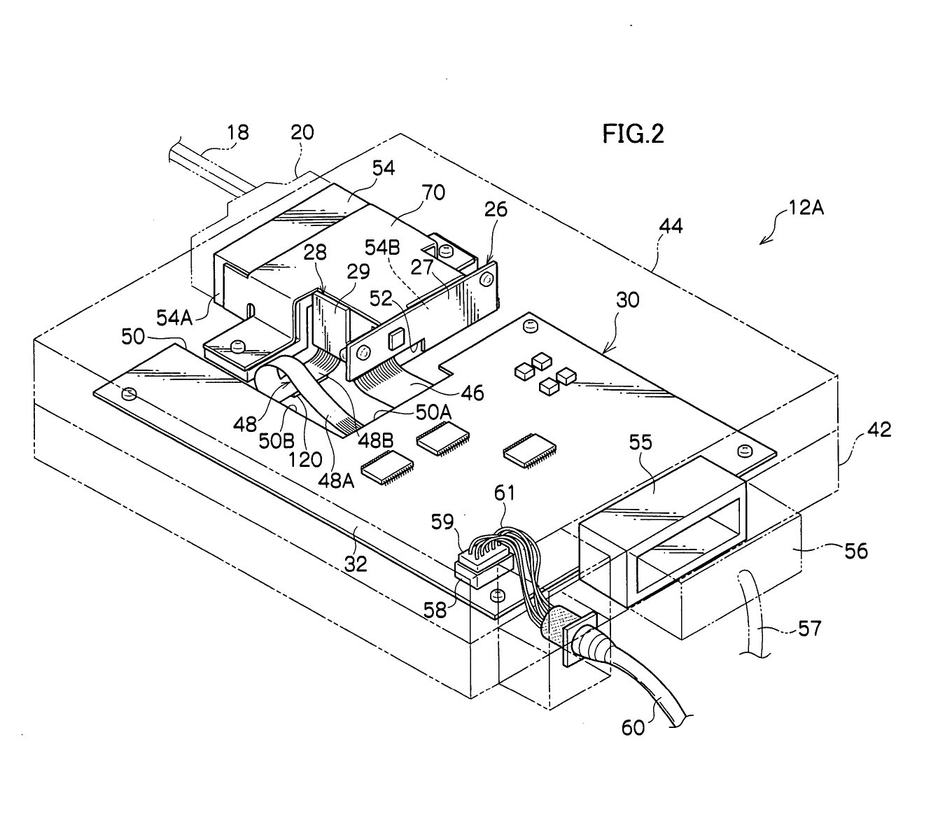

As shown in FIGS. 1 and 2, the optical signal communication apparatus 12A is connected at the host 16 side of the image signal communication apparatus system 10, and the optical signal communication apparatus 12B is connected at the monitor 14 side.

Because the optical signal communication apparatus 12A and the optical signal communication apparatus 12B have substantially similar structures, herebelow, the optical signal communication apparatus 12A will be taken as an example thereof and described.

However, it should be noted there is following differences. That is, although in the transmitting side of the apparatuses (the optical signal communication apparatus 12A), a shorter flex portion 46 transmits a signal at a higher rate and a longer flex portion 48 transmits a signal at a lower rate. In contrast, in the receiving side of the apparatuses (the optical signal communication apparatus 12B), a longer flex portion 47 transmits a signal at a higher rate and a shorter flex portion 49 transmits a signal at a lower rate.

The optical signal communication apparatus 12A is structured with an optical signal transmission section 26, an optical signal reception section 28, and a digital signal control section 30. The optical signal transmission section 26 is structured with an optical transmission module 22 and a rigid board 27, at which this optical transmission module 22 is mounted. The optical signal reception section 28 is structured with an optical reception module 24 and a rigid board 29, at which this optical reception module 24 is mounted.

As shown in FIG. 2, the optical signal communication apparatus 12A is also provided with a box-like casing body 42 and a lid portion 44, which covers an opening portion of the casing body 42. A rigid board 32, which structures the digital signal control section 30, is disposed at a bottom portion of the casing body 42. A cutaway portion 50 is formed at a corner of the rigid board 32. The cutaway portion 50 is formed in a substantial ‘L’ shape. A receptacle 54 is disposed at this cutaway portion 50 to serve as a retaining member.

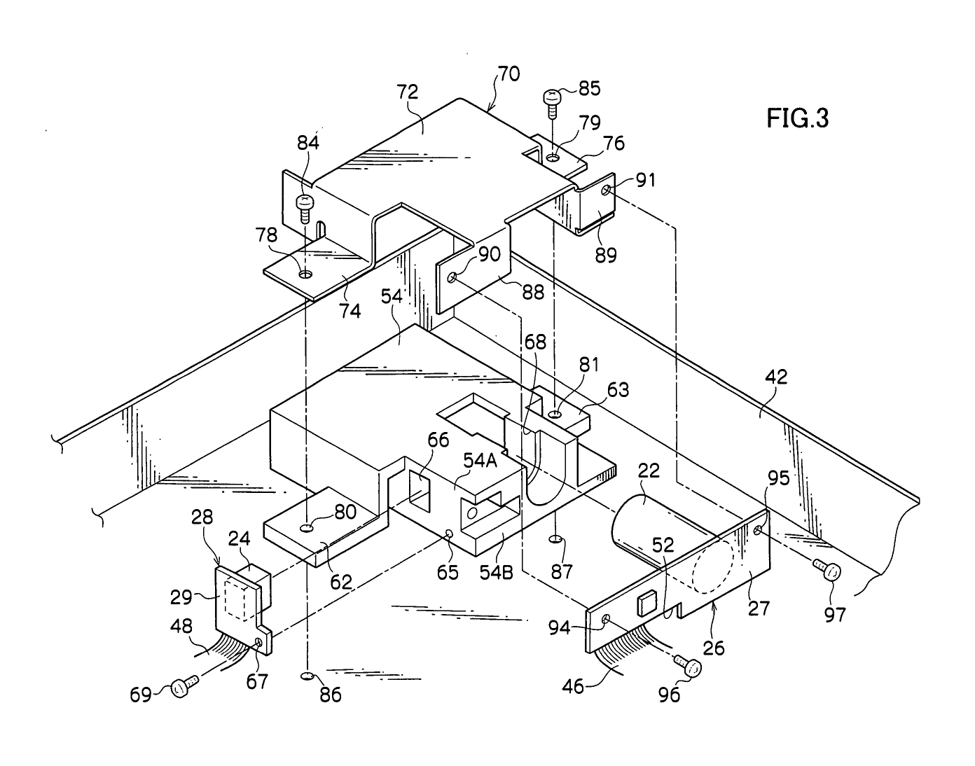

As shown in FIG. 3, the receptacle 54 is formed in a substantially rectangular box shape. A side face 54A of the receptacle 54 opposes an other edge 50B of the cutaway portion 50 (see FIG. 2). Thin board-form plate portions 62 and 63 are provided extending from respective side faces of the receptacle 54 which face the side face 54A.

The receptacle 54 is covered by a shielding member 70 from an upward side thereof. The shielding member 70 includes a substantially rectangular plate member 72. Arm members 74 and 76, which have substantial ‘L’ shapes when viewed from one direction, are provided extending from end portions at one side of the plate member 72. The arm members 74 and 76 are formed at positions which, when the receptacle 54 is covered with the shielding member 70, are superposed with the plate portions 62 and 63 formed at the receptacle 54.

Through-holes 78 and 79 are formed in the arm members 74 and 76. Through-holes 80 and 81 are formed in the plate portions 62 and 63 of the receptacle 54, and screw holes 86 and 87 are formed in the bottom portion of the casing body 42. The receptacle 54 is covered with the arm members 74 and 76 and the plate member 72, bolts 84 and 85 are inserted into the through-holes 78 and 79 and the through-holes 80 and 81, and the bolts 84 and 85 are screwed into the screw holes 86 and 87. Thus, the receptacle 54 is covered by the shielding member 70 and fixed to the bottom portion of the casing body 42.

From end portions of another side of the plate member 72, plate pieces 88 and 89 are provided protruding along a side face 54B of the receptacle 54, which opposes a one edge 50A of the cutaway portion 50 (see FIG. 2). Screw holes 90 and 91 are formed in the plate pieces 88 and 89, respectively. Through-holes 94 and 95 are formed in the rigid board 27 which structures the optical signal transmission section 26. Bolts 96 and 97 are inserted into the through-holes 94 and 95 and screwed into the screw holes 90 and 91. Thus, the rigid board 27 is fixedly retained at the shielding member 70. Accordingly, the rigid board 27 is fixedly retained at the side face 54B of the receptacle 54.

A recess portion 68, whose cross-sectional form is substantially ‘U’-shaped, is formed in the side face 54B of the receptacle 54. When the rigid board 27 is fixedly retained at the side face 54B of the receptacle 54, the optical transmission module 22 mounted at the rigid board 27, which optical transmission module 22 is cylindrical, passes through the recess portion 68 and is positioned.

A screw hole 65 is formed in the side face 54A of the receptacle 54. A through-hole 67 is formed in the rigid board 29, which structures the optical signal reception section 28. A bolt 69 is inserted into the through-hole 67 and is screwed into the screw hole 65. Thus, the rigid board 29 is fixedly retained at the side face 54A of the receptacle 54.

A substantially rectangular aperture portion 66 is formed in the side face 54A. When the rigid board 29 is fixedly retained at the side face 54A, the optical reception module 24 mounted at the rigid board 29, which optical reception module 24 has a rectangular column form, passes through the aperture portion 66 and is positioned.

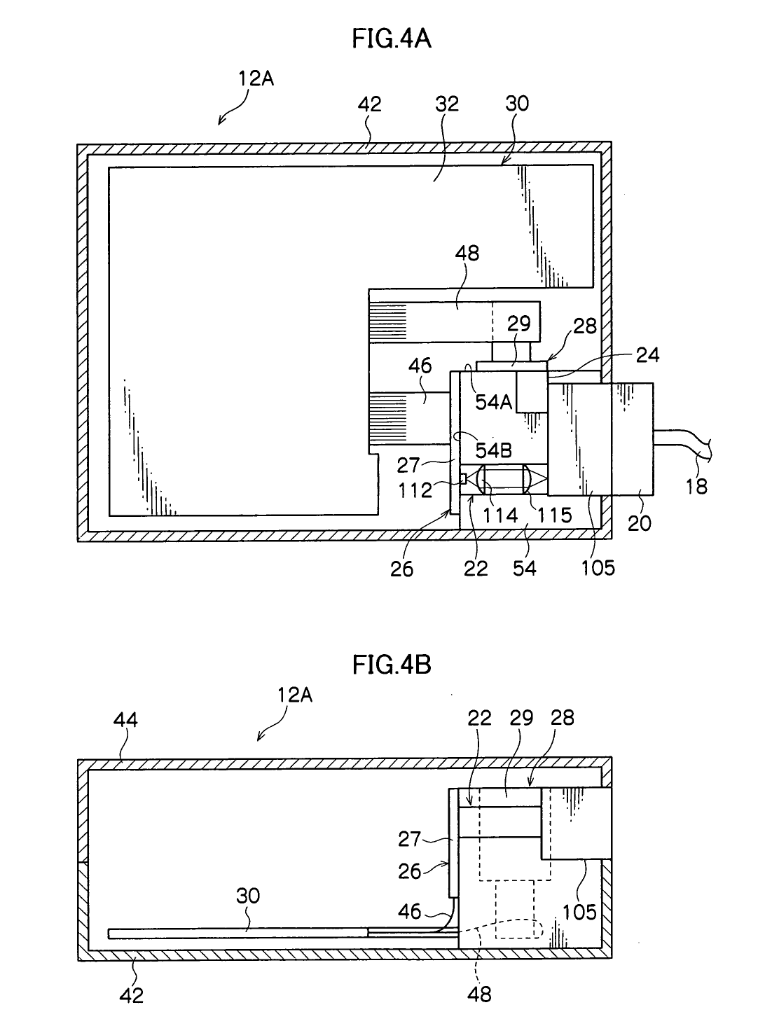

As shown in FIGS. 4A and 4B, a connector 105 is provided at a side wall of the casing body 42, coinciding with a line of length of the optical transmission module 22. A connector 20, at which an optical cable 18 is connected, is fitted together with the connector 105. At the connector 105, optical signals through the optical cable 18 to the optical reception module 24 are inputted and/or optical signals from the optical transmission module 22 are outputted.

More specifically, a light-emitting element 112 and lenses 114 and 115 are mounted at the optical transmission module 22. Optical signals emitted from the light-emitting element 112 are converted to parallel light by the lens 114, focused and guided into the connector 105 by the lens 115, and outputted to optical fiber of the optical cable 18.

Further, although not shown in the drawings, a light detection element, a detection amplifier, and a lens are mounted at the optical reception module 24. Optical signals are inputted from optical fiber of the optical cable 18 through the connector 105 to the optical reception module 24, focused by the lens and inputted to the light detection element.

As shown in FIG. 2, a female connector 58 is attached to the rigid board 32, at a side thereof that is opposite from the side thereof at which the receptacle 54 is disposed. A male connector 59 is attached to a harness 61 of a shielded cable 60. The male connector 59 fits into the female connector 58. Hence, image signals and the like from the host 16 (see FIG. 1) are transmitted through the shielded cable 60 to the digital signal control section 30 (the rigid board 32).

A female connector 55 is also provided at the rigid board 32. A male connector 56 is connected to one end of a shielded cable 57. The male connector 56 fits into the female connector 55, and control signals are transmitted through the shielded cable 57 to the host 16.

Herein, the optical signal communication apparatus 12B which is connected at the monitor 14 side (see FIG. 1) has a structure similar to the optical signal communication apparatus 12A. At the optical signal communication apparatus 12B, image signals are transmitted through a shielded cable 75 to the monitor 14, and control signals from the monitor 14 are transmitted through a shielded cable 77 to a digital signal control section 40.

Now, the rigid board 27 and the rigid board 32 are connected by a flex portion 46, and the rigid board 29 and the rigid board 32 are connected by a flex portion 48.

FIG. 5 shows a state prior to retention and fixing of the rigid boards 27 and 29 at the receptacle 54, that is, a state in which the flex portion 46 connecting the rigid board 27 with the rigid board 32 and the flex portion 48 connecting the rigid board 29 with the rigid board 32 are folded out.

The rigid boards 27, 29 and 32 and the flex portions 46 and 48 have a structure of, for example, a single board in which flexible boards with polyimide bases and rigid boards with glass epoxy bases are joined together and integrated. The flex portions 46 and 48, which are constituted by flexible boards which can be curved round, and the rigid boards 27, 29 and 32, at which electrical components are mounted, are combined with one another in this single board. In the present embodiment, the rigid boards 27, 29 and 32 are each structured by six layers, with two intermediate layers of the six layers, a third layer and a fourth layer, serving as the flex portions 46 and 48.

The rigid board 27 which structures the optical signal transmission section 26 is disposed at the one edge 50A side of the cutaway portion 50 of the rigid board 32, which structures the digital signal control section 30. A recess portion 52 of the rigid board 27 is formed at a position thereof which opposes the one edge 50A. The recess portion 52 is formed in a substantial ‘L’ shape. One end of the flex portion 46 is connected at the one edge 50A of the cutaway portion 50, and another end of the flex portion 46 is connected at the recess portion 52. Thus, the rigid board 27 is connected with the rigid board 32 by the flex portion 46, and is electrically connected.

The rigid board 29 which structures the optical signal reception section 28 is also disposed at the cutaway portion 50, so as to be parallel with the rigid board 27. The rigid board 29 is connected with the rigid board 32 by the flex portion 48, and is electrically connected.

One end of the flex portion 48 is connected at the one edge 50A of the cutaway portion 50. The flex portion 48 is structured in an ‘L ’ shape by a long side portion 48A and a short side portion 48B. The long side portion 48A is extended, in parallel with the flex portion 46, so as to have a length that reaches beyond the rigid board 27. The short side portion 48B is perpendicular to the long side portion 48A, and is provided extending in a direction which is opposite to a direction toward the other edge 50B of the cutaway portion 50. This short side portion 48B is connected at a side of the rigid board 29 that faces the other edge 50B of the cutaway portion 50.

In the state in which the flex portions 46 and 48 are folded out, as shown in FIG. 5, sides of the rigid boards 27 and 29 that are at the side of the surface of the paper of FIG. 5 are front faces thereof, and opposite sides of the rigid boards 27 and 29 are rear faces thereof. Hence, as shown in FIG. 2, the flex portion 46 is curved up through approximately 90° such that the rear face of the rigid board 27 opposes the side face 54B of the receptacle 54, and the rigid board 27 is fixedly retained.

Further, the long side portion 48A of the flex portion 48 is curved round through approximately 180° to form a loop portion, the short side portion 48B is curved up by approximately 90° such that the front face of the rigid board 29 opposes the side face 54A of the receptacle 54, and the rigid board 29 is fixedly retained.

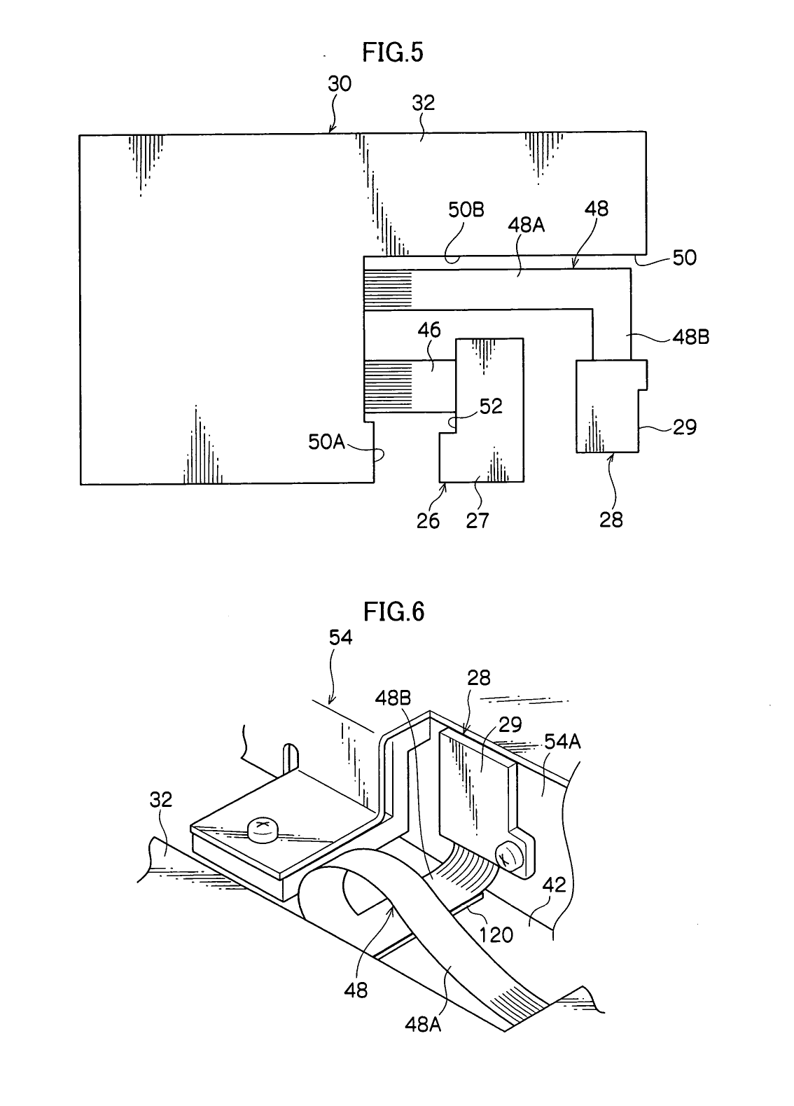

As shown in FIG. 6, an insulating member 120, which is formed of an insulative material, is adhered to the bottom face of the casing body 42 that opposes the short side portion 48B of the flex portion 48. The insulating member 120 has a thickness of around 0.5 to 5 mm.

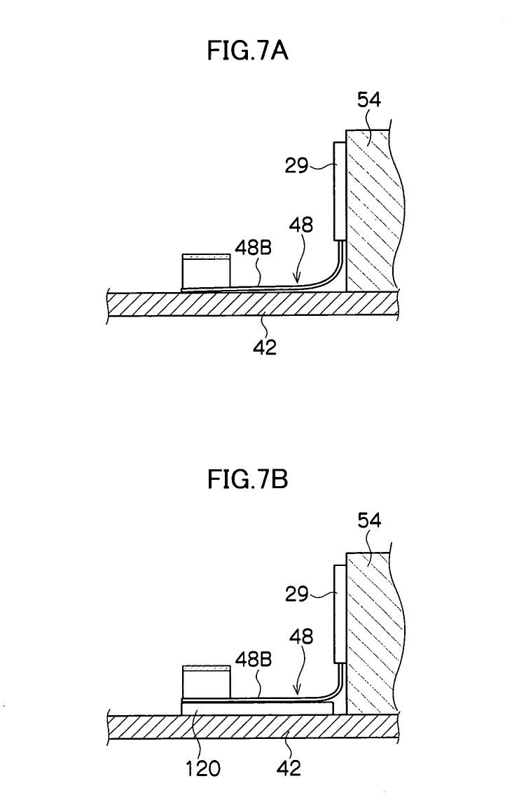

When the short side portion 48B of the flex portion 48 is caused to touch the bottom face of the casing body 42 and is curved up through approximately 90°, a very small gap is formed between the short side portion 48B and the bottom face of the casing body 42, for example, as shown in FIG. 7A. The width of this gap varies from location to location. Further, because return current flowing in the flex portion 48 flows into the casing body 42 and magnitude thereof varies in accordance with the width of the gap, there will be variations by location in return current flowing in the casing body 42. As a consequence, undesired radiation will be generated at portions of the gap.

Accordingly, as shown in FIG. 7B, the insulating member 120 is disposed at the bottom face of the casing body 42 that opposes the short side portion 48B of the flex portion 48, and return current flowing in the flex portion 48 is prevented from flowing into the casing body 42. Thus, undesired radiation is not generated.

Here, as the insulative material, a foam material, radio wave-absorbing material or the like can be employed. If a foam material with a small dielectric constant is used as the insulating body, a state of complete insulation between the flex portion 48 and the casing body 42 can be realized. Further, if an radio wave-absorbing material is used, electromagnetic waves emitted from the flex portion 48 will be absorbed by the radio wave-absorbing material, and it is possible to completely prevent transmission of electromagnetic waves to the casing body 42.

Besides the foam material and radio wave-absorbing material mentioned above, various other materials may be employed for the insulative material.

Further, in order to suppress variations in return current flowing in the casing body, it is desirable to make thickness of the insulating body constant.

Next, an optical signal communication apparatus relating to a second embodiment of the present invention will be described. Note that descriptions of portions that are the same as in the first embodiment are omitted.

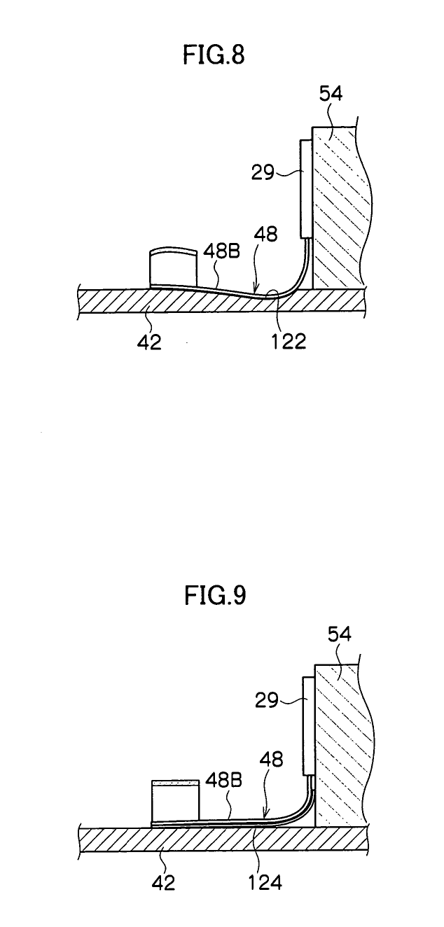

As shown in FIG. 8, a recess portion 122 is formed at a portion of the bottom face of the casing body 42 that the short side portion 48B of the flex portion 48 touches. The recess portion 122 has a dimension substantially the same as a width of the flex portion 48, and is formed so as to match a natural curve when the short side portion 48B of the flex portion 48 is inflected. The short side portion 48B of the flex portion 48 is grounded at the recess portion 122.

Hence, even if return current flowing in the flex portion 48 flows into the casing body 42, because the flex portion 48 and the casing body 42 are closely contacted, return current flowing in the casing body 42 will be constant rather than varying by location, and undesired radiation will not be generated.

Although the present embodiment has a structure in which the recess portion 122 is formed with a dimension substantially the same as the width of the flex portion 48, it is sufficient if the recess portion 122 is formed so as to match the curve of the flex portion 48. It is not necessary for the width direction dimension to be substantially the same as the width of the flex portion 48.

Next, an optical signal communication apparatus relating to a third embodiment of the present invention will be described. Note that descriptions of portions that are the same as in the first embodiment are omitted.

As shown in FIG. 9, a conductive tape 124 is adhered to a face of the short side portion 48B of the flex portion 48 that faces the bottom face of the casing body 42.

Hence, if the conductive tape 124 even partially touches the casing body 42, a state in which the whole of the short side portion 48B of the flex portion 48 is in contact with the casing body 42 is realized. Accordingly, variations from location to location of return current flowing in the casing body 42 are eliminated, and undesired radiation will not be generated.

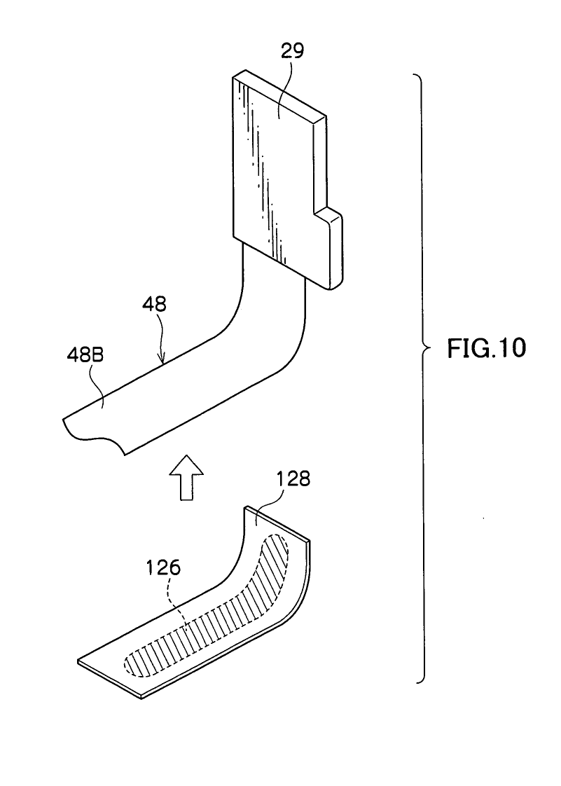

Here, as shown in FIG. 10, it is also possible to adhere a tape at which a periphery of a conductive tape 126 is covered with an insulating member 128 to the casing body 42 side face of the short side portion 48B of the flex portion 48 (see FIG. 9). In such a case, the insulating member 128 passes in between the flex portion 48 and the conductive tape 126 to cover a whole area therebetween, or the flex portion 48 and the conductive tape 126 are in a state of direct contact. An exposed portion of the conductive tape 126 touches the casing body 42. Hence, because the periphery of the conductive tape 126 is covered with the insulating member 128, even if a portion of the conductive tape 126 whose periphery is covered with the insulating member 128 peels off from the flex portion 48, the insulating member 128 will touch other components rather than the conductive tape 126 touching other components. Therefore, there is no risk of short-circuits between the conductive tape and other components.

Next, an optical signal communication apparatus relating to a fourth embodiment of the present invention will be described. Note that descriptions of portions that are the same as in the first embodiment are omitted.

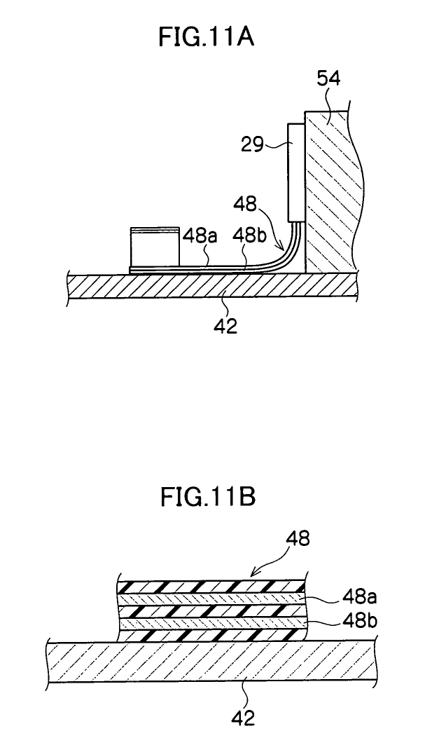

As shown in Figs. 11A and 11B, the flex portion 48 is structured with two layers, a signal layer 48a, in which signal wiring is formed, and a ground layer 48b, in which a grounded region is formed and return current flows. Fig. 11B shows an enlargement of a layer structure of the flex portion 48 of the present embodiment. The ground layer 48b is disposed at the casing body 42 side of the short side portion 48B of the flex portion 48 which touches the casing body 42.

Hence, because the ground layer 48b in which return current flows is disposed at the casing body 42 side, return current flowing in the flex portion 48 will all flow through the ground layer 48b and there will be no variations by location of return current flowing in the casing body 42. Accordingly, the generation of undesired radiation can be suppressed.

Next, an optical signal communication apparatus relating to a fifth embodiment of the present invention will be described. Note that descriptions of portions that are the same as in the first embodiment are omitted.

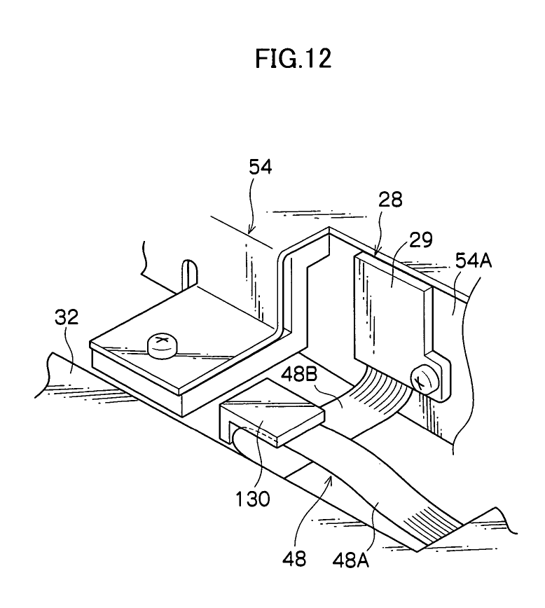

As shown in FIG. 12, a pressing member 130, which is formed of an insulator in a substantial ‘L’ shape as viewed from one side of the casing body 42, is provided so as to press against the loop portion that is formed when the long side portion 48A of the flex portion 48 is curved round through 180°. With this pressing member 130, a structure in which the loop portion of the flex portion 48 is pressed toward the casing body 42 is realized.

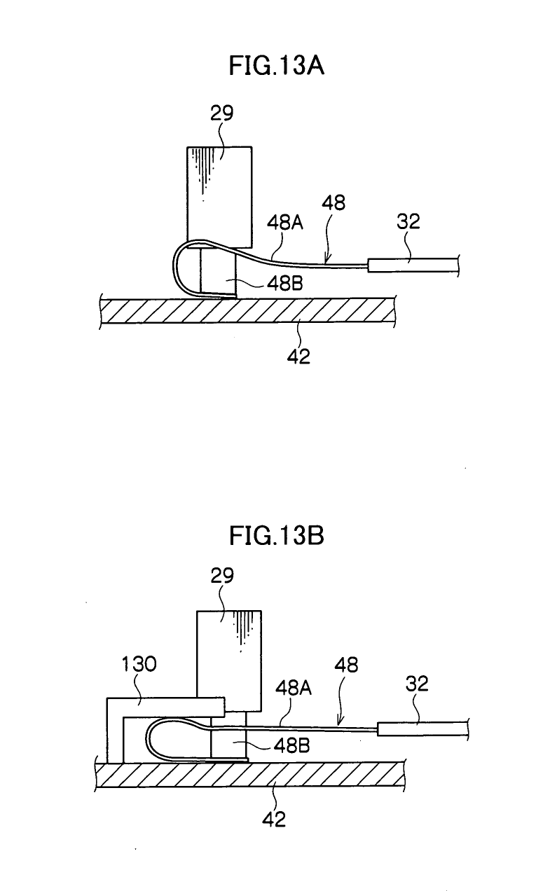

FIG. 13A shows the loop portion of the flex portion 48 in a non-pressed state, and FIG. 13B shows the state in which the loop portion is pressed toward the casing body 42 by the pressing member 130. Thus, when the loop portion is pushed toward the casing body 42, a loop radius is made smaller, and the loop portion, which is to say the long side portion 48A of the flex portion 48, can be caused to touch the casing body 42 over a wide region. Accordingly, the long side portion 48A of the flex portion 48 is in a state of close contact with the casing body 42, and it is possible to suppress the generation of undesired radiation.

Note that although the present embodiment has a structure in which the pressing member 130 which pushes the loop portion of the flex portion 48 is provided at the casing body 42, a structure in which a pressing member is provided at the receptacle 54 is also possible.

What is claimed is:

1. An optical signal communication apparatus comprising:
a light transceiving section, which performs at least one of transmission and reception of optical signals;
a digital signal control section which is disposed in a casing body and processes digital electronic signals from the light transceiving section; and
a flexible wiring board connecting the light transceiving section with the digital signal control section,
wherein the flexible wiring board is disposed on an insulating member provided at the casing body.

2. The optical signal communication apparatus of claim 1, wherein the insulating member comprises a foam material.

3. The optical signal communication apparatus of claim 1, wherein the insulating member comprises an Radio wave-absorbing material.

4. The optical signal communication apparatus of claim 1, wherein the insulating member comprises a thickness which is substantially constant in a range of 0.5 to 5 mm.

5. The optical signal communication apparatus of claim 1, wherein the light transceiving section comprises a transmitting section and a receiving section, the transmitting section including an optical transmission module, and the receiving section including an optical reception module.

6. The optical signal communication apparatus of claim 5, further comprising a connector, wherein the connector is connected to an external optical cable, the optical transmission module transmits optical signals through the connector to the optical cable, and the optical reception module receives optical signals through the connector from the optical cable.

7. An optical signal communication apparatus comprising:
a light transceiving section, which performs at least one of transmission and reception of optical signals;
a digital signal control section which is disposed in a casing body and processes digital electronic signals from the light transceiving section; and
a flexible wiring board connecting the light transceiving section with the digital signal control section,
wherein the flexible wiring board is disposed along a recess portion formed at a bottom face of the casing body and the flexible wiring board is inflected such that an end portion thereof is substantially perpendicular to the bottom face of the casing body.

8. The optical signal communication apparatus of claim 7, wherein the light transceiving section comprises a transmitting section and a receiving section, the transmitting section including an optical transmission module, and the receiving section including an optical reception module.

9. The optical signal communication apparatus of claim 8, further comprising a connector, wherein the connector is connected to an external optical cable, the optical transmission module transmits optical signals through the connector to the optical cable, and the optical reception module receives optical signals through the connector from the optical cable.

10. An optical signal communication apparatus comprising:
a light transceiving section, which performs at least one of transmission and reception of optical signals;
a digital signal control section which is disposed in a casing body and processes digital electronic signals from the light transceiving section; and
a flexible wiring board connecting the light transceiving section with the digital signal control section,
wherein a conductive member is disposed at a side of the flexible wiring board that faces a bottom face of the casing body.

11. The optical signal communication apparatus of claim 10, wherein the conductive member comprises a sheet form, a peripheral edge of which is covered with an insulating member.

12. The optical signal communication apparatus of claim 10, wherein the light transceiving section comprises a transmitting section and a receiving section, the transmitting section including an optical transmission module, and the receiving section including an optical reception module.

13. The optical signal communication apparatus of claim 12, further comprising a connector, wherein the connector is connected to an external optical cable, the optical transmission module transmits optical signals through the connector to the optical cable, and the optical reception module receives optical signals through the connector from the optical cable.

14. An optical signal communication apparatus comprising: a light transceiving section, which performs at least one of transmission and reception of optical signals;
a digital signal control section which is disposed in a casing body and processes digital electronic signals from the light transceiving section; and
a flexible wiring board connecting the light transceiving section with the digital signal control section,
wherein the flexible wiring board is structured by at least two layers, including a signal wiring layer at which signal wiring is formed and a ground layer at which a grounded region is formed, the ground layer being disposed at a side of the flexible wiring board that faces a bottom face of the casing body.

15. The optical signal communication apparatus of claim 14, wherein the light transceiving section comprises a transmitting section and a receiving section, the transmitting section including an optical transmission module, and the receiving section including an optical reception module.

16. The optical signal communication apparatus of claim 15, further comprising a connector, wherein the connector is connected to an external optical cable, the optical transmission module transmits optical signals through the connector to the optical cable, and the optical reception module receives optical signals through the connector from the optical cable.

17. An optical signal communication apparatus comprising:
a light transceiving section, which performs at least one of transmission and reception of optical signals;
a digital signal control section which is disposed in a casing body and processes digital electronic signals from the light transceiving section; and
a flexible wiring board connecting the light transceiving section with the digital signal control section,
wherein a pressing member is formed at the casing body, an intermediate portion of the flexible wiring board is inflected through approximately 180° for forming a loop portion, an end portion of the flexible wiring board is inflected to be substantially perpendicular to a bottom face of the casing body, and the pressing member presses the loop portion toward the casing body.

18. The optical signal communication apparatus of claim 17, wherein the light transceiving section comprises a transmitting section and a receiving section, the transmitting section including an optical transmission module, and the receiving section including an optical reception module.

19. The optical signal communication apparatus of claim 18, further comprising a connector, wherein the connector is connected to an external optical cable, the optical transmission module transmits optical signals through the connector to the optical cable, and the optical reception module receives optical signals through the connector from the optical cable.

20. An optical signal communication system comprising:
a first optical signal communication apparatus, which includes
a first light transceiving section, which performs at least one of transmission and reception of optical signals,
a first digital signal control section, which is disposed in a first casing body and performs at least one of
processing digital electronic signals from the first light transceiving section and outputting digital electronic signals to a host via an electrical cable and
processing digital electronic signals inputted from the host and outputting digital electronic signals to the first light transceiving section, and
a first flexible wiring board connecting the first light transceiving section with the first digital signal control section; and
a second optical signal communication apparatus, which includes a second light transceiving section, which performs at least one of transmission and reception of optical signals,
a second digital signal control section, which is disposed in a second casing body and performs at least one of
processing digital electronic signals from the second light transceiving section and outputting digital electronic signals to a monitor via an electrical cable and
processing digital electronic signals inputted from the monitor and outputting digital electronic signals to the second light transceiving section, and
a second flexible wiring board connecting the second light transceiving section with the second digital signal control section,
wherein the first flexible wiring board is disposed on an insulating member provided at the first casing body and the second flexible wiring board is disposed on an insulating member provided at the second casing body.
